(19) United States
(12) Patent Application Publication
(10) Pub. No.: US 2014/0148736 A1
(43) Pub. Date: May 29, 2014

(54) CONTINUOUS PASSIVE MOTION APPARATUS

(71) Applicant: Leslie Hoffman, Tarzana, CA (US)

(72) Inventor: Leslie Hoffman, Tarzana, CA (US)

(21) Appl. No.: 14/049,734

(22) Filed: Oct. 9, 2013

Related U.S. Application Data
(60) Provisional application No. 61/711,315, filed on Oct. 9, 2012.

(51) Int. Cl. A61H 1/00

(52) U.S. Cl. CPC A61H 1/00
USPC 601/5

(57) ABSTRACT

An easily dismantled continuous passive motion system for rehabilitating a knee joint with the drive applied directly to the knee joint portion of the device.

### CROSS REFERENCE

This application is a utility case conversion of U.S. Provisional Application 61/711,315, filed Oct. 9, 2012 and this application claims the benefit of this provisional filing. This provisional application is hereby incorporated by reference in its entirety.

### BACKGROUND OF THE INVENTION

Continuous passive motion (CPM) machines are designed to flex a joint through a controlled range of motion to help patients rehabilitate and recover from surgeries or other treatments on the joint.

Initially such machines were very large and cumbersome, and they were typically attached to a bed or integrated with the patient bed in a manner that prevented portability of the therapy device.

More recently unitary but otherwise portable devices such as the OptiFlex by Chattanooga Group (a brand of DJO Global, Inc., Guildford, Surrey, England) have been introduced to provide a compact CPM machine to provide CPM therapy outside the hospital setting.

In spite of these advances there is a continuing need to improve CPM devices to improve patient care.

### SUMMARY OF THE INVENTION

The CPM device of the present invention is unique in several respects and for clarity it is disclosed in the context of treatment of a knee but the principles can be applied to other joints.

The device has a hinge-like knee joint assembly that is positioned proximate the patients knee joint. The knee joint assembly is driven by a small motor and integrated gear train attached directly to the knee joint assembly. The motor and gear train drives the knee joint assembly directly without intermediary linkages.

The patient's heel is carried in a carriage that rolls along a pad-mounted track. Together the carriage and track set the path for the motion of the device hinge and thereby flex the patient's knee joint. No permanent connection is required to the bed The track may be positioned on the surface of the bed and need not be fixed in position.

A pad attached to the track is placed under the patient's hips so that there is no relative movement between the patient's torso and the track. All motion along the track is fixed with respect to the torso by this feature. In practice there is no side-to-side motion because the wheels of the carriage are constrained by the track and no longitudinal displacement occurs because the patient's torso is anchored to the track by resting the patient's weight on the pad.

Although quite stable in use, the assembly can be quickly and easily dismantled and broken down into functional assemblies that can be accommodated in a duffel-bag or the like.

It is anticipated that the device may be sent home with the patient to ensure early use in rehabilitation.

An electronic control console is available for the patient to set and modify normal motion parameters. Additional functionality is incorporated to protect and improve the comfort of the patient. For example, in the event of a loss of power the carriage and joint return to known and defined home position. It is expected that this home position will result in the leg being generally horizontal.

### DESCRIPTION OF THE DRAWINGS

Throughout the drawings like numerals identify like structure wherein,

FIG. 1 is a schematic view of the device in use by a patient;

FIG. 2 shows the major subassemblies in a exploded relationship;

FIG. 3 shows the Foot Frame Assembly (FFA) in isolation;

FIG. 4 shows the Track Pad Assembly (TPA) in isolation;

FIG. 5 shows the Leg Frame Assembly (LFA) in isolation;

FIG. 6 shows the Knee Joint Assembly (KJA) in isolation;

FIG. 7 shows one KJA in exploded form;

FIG. 8 shows the left side KJA in isolation coupled to related components;

FIG. 9 shows the controller in isolation; and,

FIG. 10 is a block diagram showing the architecture of the control system.

### DETAILED DESCRIPTION OF THE INVENTION

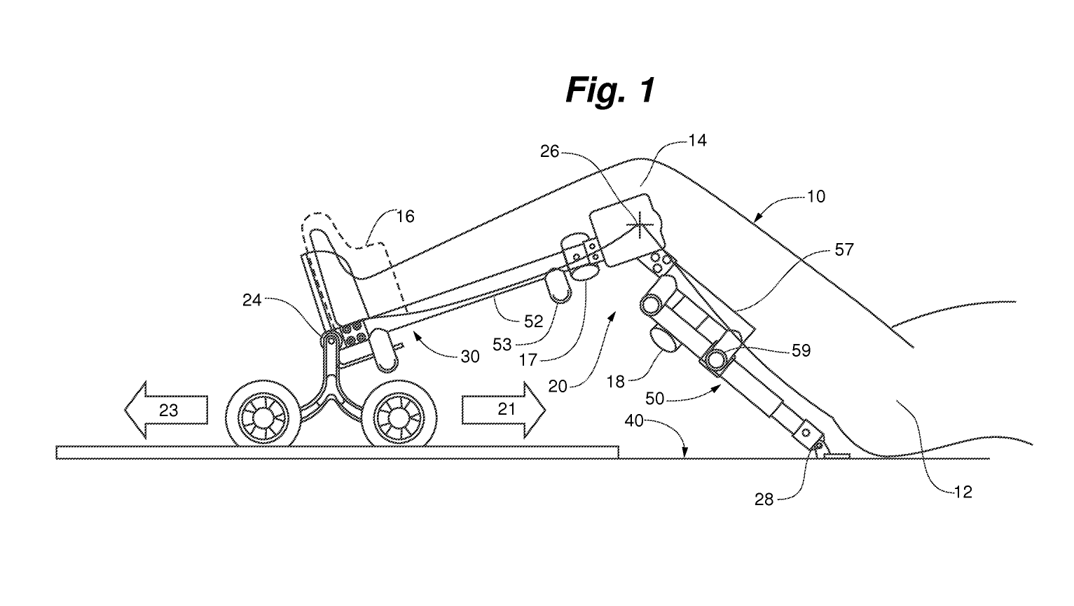

FIG. 1 shows the continuous passive motion (CPM) device 20 in use by a patient 10. The CPM device or machine can be readily broken down into several subassemblies such as a Foot Frame Assembly (FFA) 30, a Track Pad Assembly (TPA) 40, and a Leg Frame Assembly (LFA) 50.

In use the patient 10 anchors and stabilizes the TPA 40 by putting the hips 12 on a portion of the TPA 40 thereby transferring weight to the CPM device 20 fixing the motion of the machine to the bed (not seen) and the patient's knee joint 14. With CPM device 20 fixed with respect to the hips 12 the Foot Frame Assembly 30 may move in a first direction 21 toward the hips 12 and a second direction 23 away from the patient's hips. These two motions can be controlled and result in therapeutic flexion of the knee joint 14.

To achieve these motions the CPM device 20 includes a foot frame pivot axis 24, a knee joint pivot axis 26 and a track pad pivot axis 28. The controlled motion is driven by a motor and gearbox associated with the Leg Frame Assembly 50.

An over-boot schematically illustrated at 16 helps to position the patient's foot in the FFA 30. One or several adjustable straps indicated schematically at 16 and 17 are used to support the patient's leg in the CPM device 20. In general the axis 26 will align with the center of motion of the patient's knee.

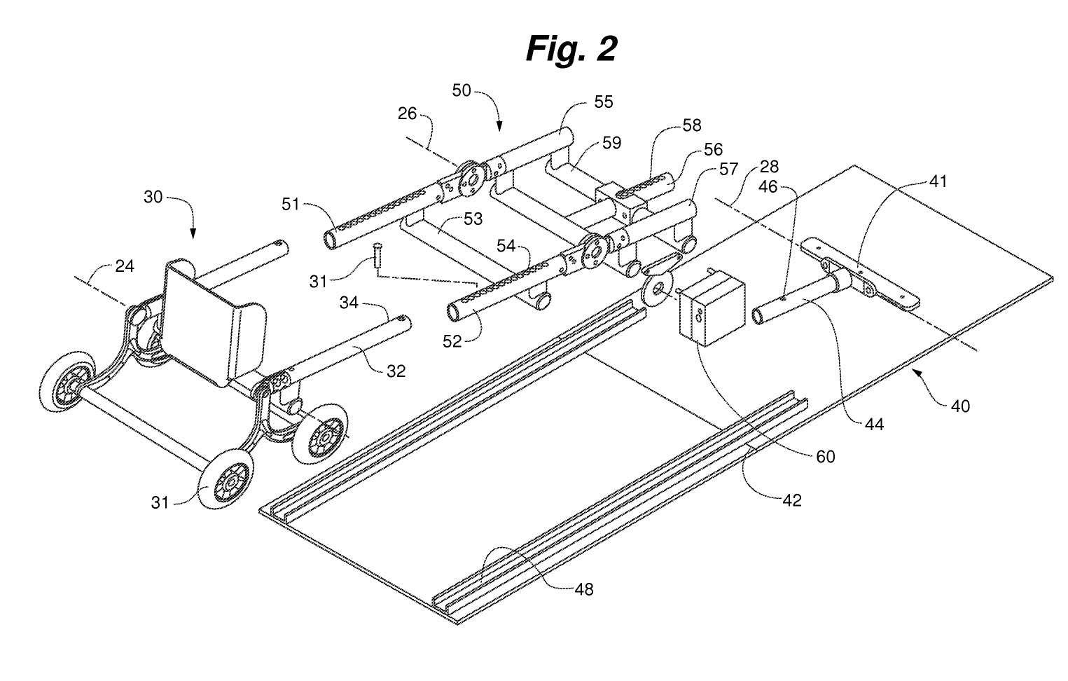

FIG. 2 shows the major subassemblies in a exploded relationship. That is the FFA 30 has been detached from the LFA 50 that in turn has been detached from TPA 40.

In practice TPA 40 will be folded along hinge line 42, and the assemblies stored in a duffel-like bag not seen for ease of transport.

In this specific implementation pairs of telescoping tubes permit length adjustment. In the figure the FFA inner tube 32 can slide into LFA outer tube 52 and the tubes locked together by spring loaded pins or clevis pins or ball-lok pins or the like represented in the figure by pin 31 that may be introduced into the open holes in the telescoping assemblies. For example the multiple holes in LFA outer tube 52 typified in the figures by representative hole 54 cooperate with the FFA inner tube hole 34 to permit adjustment of the relative position of the pivot axis to accommodate variations in leg length and geometry differences between patients. A pin like pin 31 maybe inserted into the aligned holes to anchor the position between the telescoping tubes.

In a similar fashion the TPA 40 may be coupled to the LFA 50 by mating LFA outer tube 56 with TPA inner tube 44 and securing them in a fixed relationship with suitable pins inserted into holes typified by LFA hole 58 and TPA hole 46.

Also seen clearly in this figure are the wheels of FFA 30 typified by wheel 34 which can travel in TPA track 48 thereby constraining the motion to a well-controlled and repeatable path, thereby providing repetitive controlled motion.

Also seen clearly in this figure is the gear-motor assembly (GMA) 60, which mounts along axis 26.

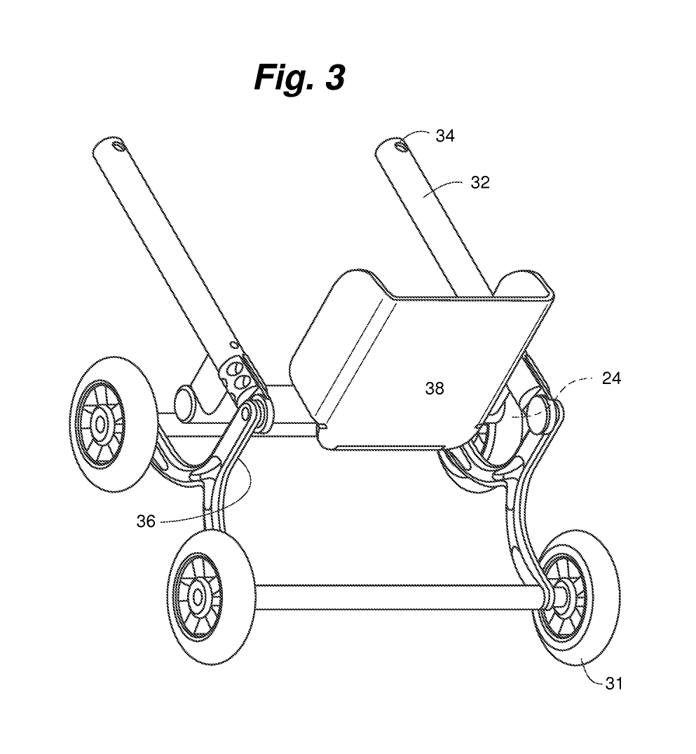

FIG. 3 shows the FFA 30 in isolation. Preferably four wheels typified by wheel 32 are coupled to a riser frame 36 that serves to position the wheels in the TPA tracks 48 and fix the relationship with the FFA pivot axis 24. In general the wheelbase and track width and wheel diameter of the FFA components is selected to ensure that the pivot axis tracks accurately along the wheel path defined by the FFA 30 together with TPA 40. The overall objective is to make sure that the FFA 30 is not “tippy” and that it does not “jump” out of the tracks on the TPA 40.

The patient's foot rests in foot-rest 38 which is coupled to the inner tubes of the FFA. This configuration avoids forcing a rotation of the ankle joint in response to motion 21 or motion 23. As seen in FIG. 1 a soft protective boot 16 positions the foot in the foot rest 38.

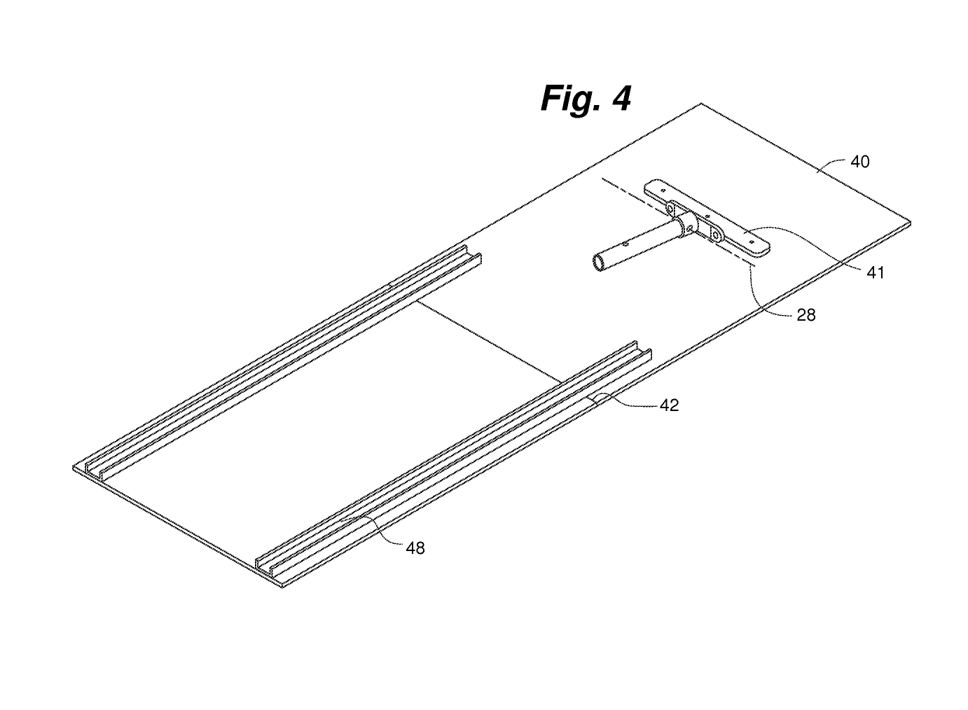

FIG. 4 shows the TPA 40 in isolation. A pair of tracks typified by track 48 guide the wheels, typified by wheel 34 of the FFA 30 along a linear path aligned substantially with the patients back. These track elements in conjunction with the wheels force the reciprocating motion 21 and 23 to be highly repeatable which is believed to be a benefit to the patient. The hinge plate 41 establishes the location axis 28 at a location near the patient's hips and at the level of the back. Typically the patient slides the hips 12 up to and proximate the hinge plate 41 while resting body weight on the extended portion of the pad itself. A cover covering the entire TPA may be added to the assembly to improve comfort and friction with the surface of the bed.

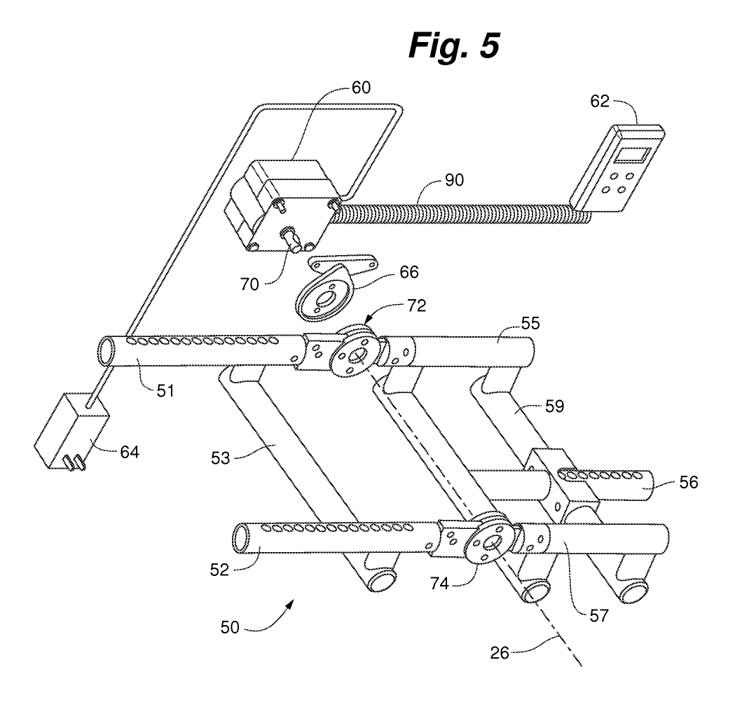

FIG. 5 shows the Leg Frame Assembly (LFA) 50 in isolation along with closely associated components such as the gear /motor 60. The attached controller 62, the power supply 64 and the drive mount 66.

Mains power is supplied via a power transformer supply 64 to the electronics located in the gear motor 60 and the controller 62. A preferred partitioning of the electronic componentry is described anon. Note that the controller and power supply are supplied with appropriate cabling such as cable 90 to interact with each other.

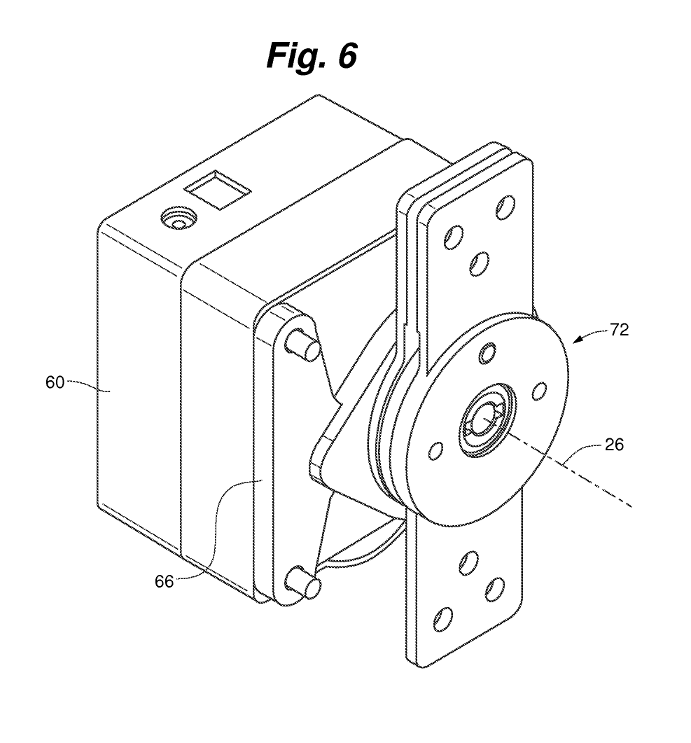

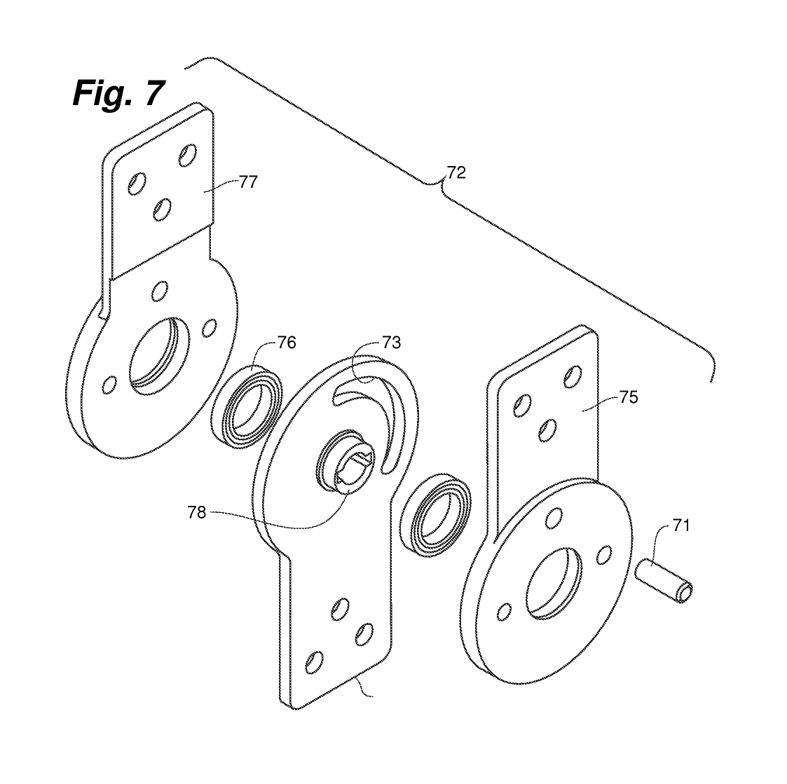

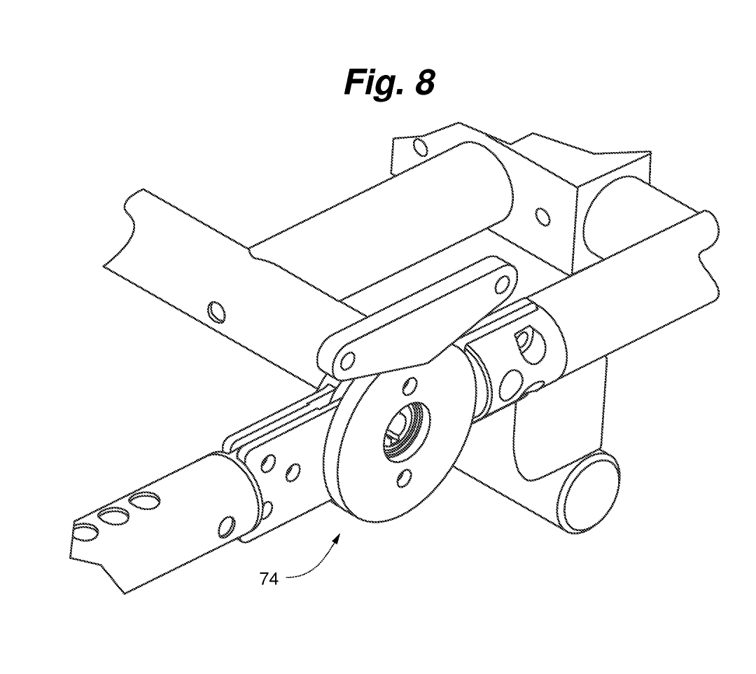

The drive mount can be attached to either right side Knee Joint Assembly (KJA) 72 or left side KJA 74. In use the gear motor 60 will be on the “outside” of the leg frame so as to not interfere with the patient's other leg. As seen in the figure, the CPM device is being set up for use with the right leg. A set of apertures in the drive mount 66 mate with the gear motor 60 fixed by screws or bolts and drive one arm of the KJA. The drive shaft 70 is keyed to the other arm of the KJA so that the reaction forces set up drive the joint assembly hinge without other structures or complexities as further described in FIG. 6 and FIG. 7.

In this figure, the complementary support tubes 51, 52 and 53 together form a support cradle for the patient's upper calf. The calf is supported and positioned in the cradle with an appropriate strap 17. In a similar fashion the complementary support tubes 55, 57 and 59 form a support cradle for the patients thigh. The thigh is supported and positioned in the cradle with an appropriate strap 18. These two cradles together may be adjusted to accommodate the leg of the patient and put the patient's knee joint in alignment with the knee joint axis 26.

FIG. 6 shows the Knee Joint Assembly 72 and the gear motor 60 in isolation. The gear motor 60 is bolted to the motor mount 66. When activated the anterior attachment tabs and posterior attachment tab move in opposite directions about axis 26. The reaction forces from the gear motor housing drive one arm 54 while the keyway and shaft 70 drive the companion arm. The drive mount 66 and gear motor can be swapped from KJA 74 to KJA 72 quickly and easily with a small handful of readily accessible bolts.

FIG. 7 shows one KJA in exploded form. A pair of bearings typified by bearing 76 support shaft 78 that acts as an axle allowing tabs 77 and 75 to rotate about an axis with respect to tab 79 mounted to shaft 78. It is important that the gear motor assembly not force rotation of the patient knee joint too far. The pin 71 interacting with slot 73 limits overall travel of the KJA to about an included angle of about 120 degrees. This mechanical fail safe mechanism provides patient safety. The tabs are coupled to the arms typified by arm 52 of the LFA.

FIG. 8 shows the left side KJA coupled to related components.

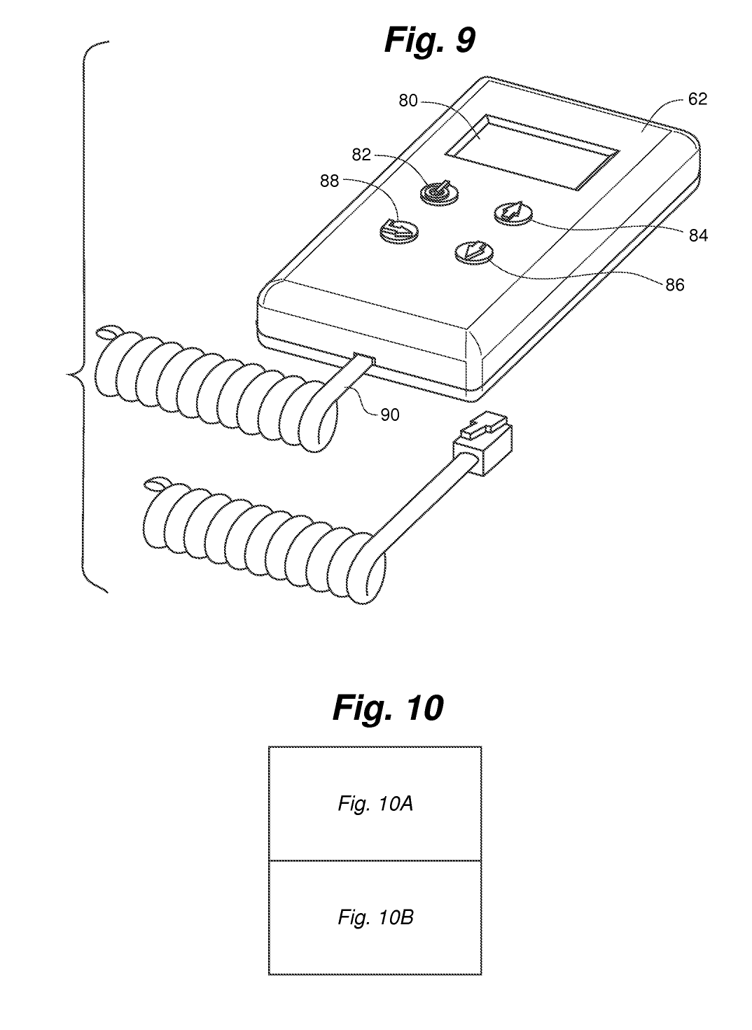

FIG. 9 shows the controller 62 in isolation. In general the patient will set the therapy protocol in conjunction with the attending physician. It is believed that patient comfort and effectiveness is enhanced by starting therapy quickly after surgery. The patient will set the overall joint motion as well as duration of the therapy via the controller 62.

By way of example it is preferred to provide four push buttons and an LCD screen 80 on the controller. 62 The controller 62 is connected to the gear motor 60 drive unit with a four conductor coiled modular cable 90. The power from transformer power supply 64 comes through the cable 90 on two of the conductors. The remaining conductors carry a go/stop motor signal and single line communication signal.

When the power comes on a three second splash screen is displayed on display 80, then the term “Flexion” with a default value of 70 degrees for total KJA motion. The setting can be changed up or down in 5 degree increments to a value between 30 and 120 by using the up button 84 or down push button 86.

When ready, the patient will push the Next button 88 and “Xtension” with a default value of zero degrees is displayed. This setting can be changed in 5 degree increments up to a maximum of 5 degrees less than the Flexion setting. Pushing the Next button 88 again will get you to the “Speed” screen that displays the default of 2 degrees per second. This can be changed to 1 or 3. Next again and you see the default “Time” of 2 hours. This can be set in 1 hour increments to a treatment time of 1 to 6 hours.

This finishes the settings. When you push Next (88) again the controller 62 saves these settings, transmits them to the gear motor 60 drive unit and displays a prompt for you to press the Stop/Start button 82. If the extension setting is greater than zero, the drive will move to this position at this time. This allows the patient to position himself after the machine is in the proper position. At the next treatment the new settings will be displayed as the defaults, so any changes will be minor.

After the Stop/Start button is pressed, the drive is started and a countdown clock is displayed. The stop/Start button is used to pause the operation and if pushed a second time, will terminate the treatment early. To restart after a pause, push the Next button. On any stop, the drive unit will transmit all of the motion state variables to the control module so that they are saved in two places-drive and control. On a restart they will be compared for error check purposes. This will also occur during the power fault routine, which is covered in the drive section discussion.

It is preferred to use a 2-pole, Hall commutated, brushless DC motor driving a 6632:1 gear train to implement the gear motor assembly 60.

The power is supplied by an international AC voltage to 12-volt DC wall plug transformer 64. In the controller the voltage is regulated down to 5 volts for the electronics, but the motor winding uses the 12 volts.

For patient safety and comfort the device lays the leg flat on the bed if wall power is lost for any reason. This feature is implemented with a power fault detection circuit that uses a 5.6 volt Zener to establish a voltage that is 5.6 volts less than the 12 volt line and a 3.3 volt Zener to give 3.3 volts above ground. These voltages are attached to the non-inverting and inverting inputs of a comparator. If the 12 volt line falls below 8.9 volts, the comparator changes state. This output is sent to the controller logic where it triggers an interrupt, which in turn stops the motor and seconds an output to a circuit that connects a normally diode isolated 9 volt battery to the 12 volt line. After the controller logic has saved all the variables and transmitted them to the control for saving there, it disconnects the battery and everything powers down.

Proper operation of the device relies on the machine being in the Home or zero degree position when power is applied. If this is not the case, downward force on the hinge can back drive the motor until the frame encounters the zero degree stop.

When power is applied, the drive processor initializes and waits for a Reset signal on the communication line. At the conclusion of the Reset, it acknowledges the Reset and receives the Flexion setting (8 bits, 1 bit at a time). Then three more settings (Extension, Speed, and Time) are received in like manner.

At the conclusion of this communication routine, the motor is started and moves the machine to the Extension angle. It then waits for the Enable line to be set. During this wait, the patient is positioned in the machine. The treatment motion is started when the Enable line is set. This motion consists of the machine moving from the Extension angle to the Flexion angle and back at the set speed, repeating this continuously until the Enable line is cleared.

The processor determines position and speed information from the 6-state Hall device encoder that is used for the commutation of the brushless DC motor. The gear train ratio and the number of motor poles determine the number of state changes per degree of output shaft rotation. In this case there are 111 state changes per degree. The speed can be determined by the frequency of the state changes or the time of one revolution of the motor.

A stepper motor or DC motor-encoder could also be used in this device with attendant changes in the processor code.

An obstruction detector is in the code. If the obstruction occurs in mid-range the motor is turned off and a notification is sent to the patient interface so that a proper restart can occur once the obstruction is cleared. If the obstruction occurs at an end point, the position register is reset to its proper value and the direction of motion is reversed. This feature is also used to re-home the device if the position is otherwise corrupted.

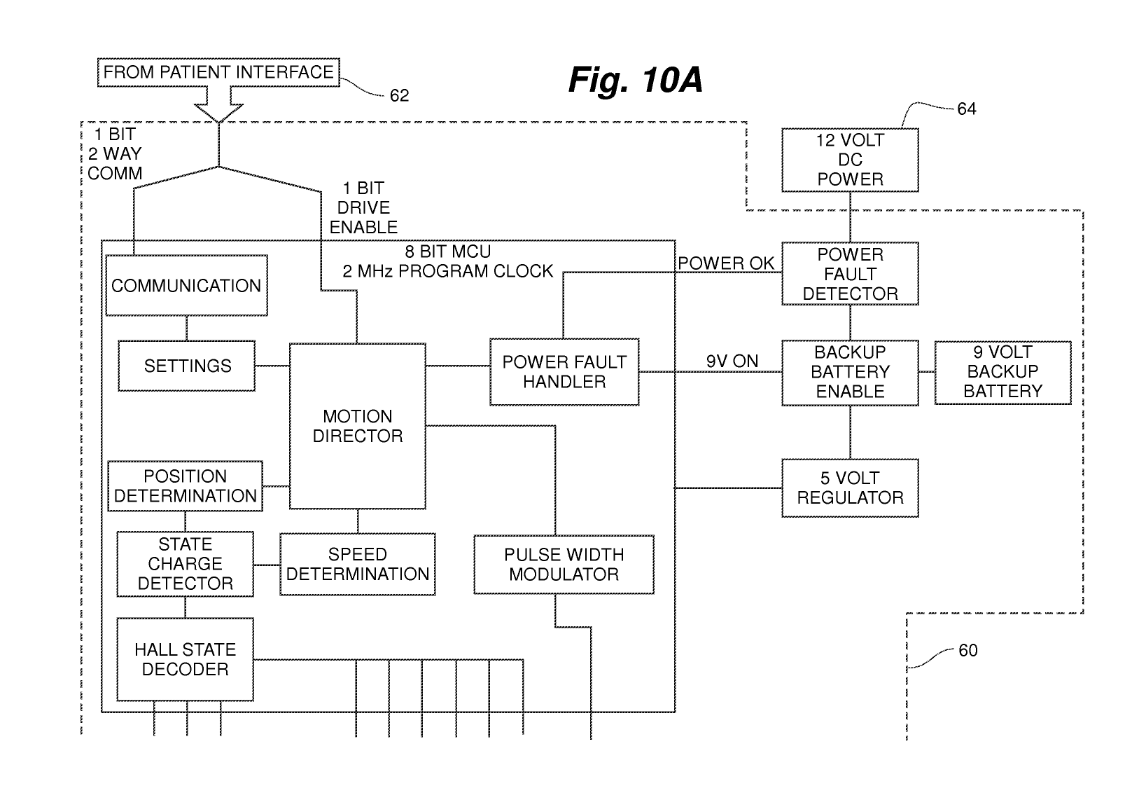

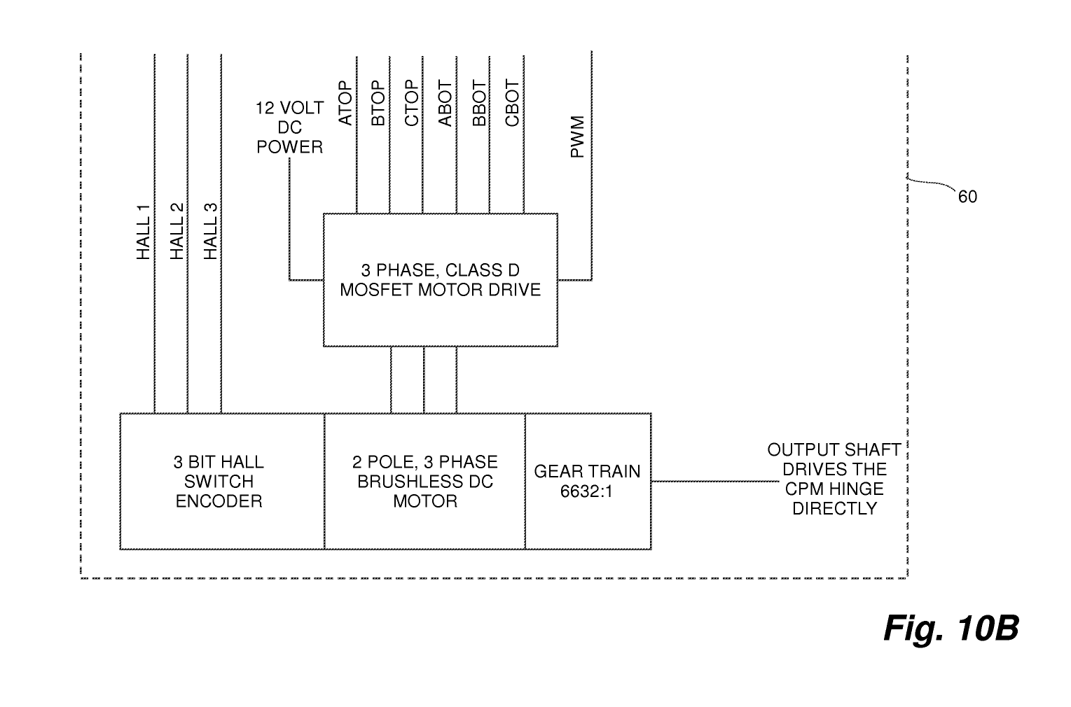

FIG. 10 shows a preferred implementation of the controller logic and motor drive circuitry. The logic is on a circuit board within the gear motor assembly 60. The gear motor assembly 60 receives power from MOSFET transistors on the same circuit board.

In the event of a power failure, the power fault detector senses the 12-volt line falling below 9 volts. In that case, it clears the “pwr OK” line which cause the processor to set the “9 v on” which connects a 9 volt backup battery to the 5 volt regulator input. The process then causes the machine to return to the Home position. When Home is reached, the “9 v on” line is cleared and the machine is turned off.

What is claimed is:

1. A continuous passive motion device for providing therapy to a patient, said patient having legs attached to hips, each leg having a calf, thigh and knee joint, the device comprising:
a foot frame assembly having a riser carrying a set of wheels, a foot rest coupled to said riser by a pivot defining a foot frame axis;
a leg frame assembly including a calf support cradle coupled to a knee joint assembly, which in turn is coupled to a thigh support cradle;
a gear motor connected to said knee joint assembly to drive the device to flex the patient knee joint;
said knee joint assembly having a coupler to transfer gear motor torque to said calf support cradle and a coupler to transfer gear motor reaction torque to said thigh support cradle thereby flexing said knee joint;
a track pad assembly having a set of tracks adapted to receive said wheels whereby together the wheels and tracks define a motion path toward and away from said hips.

2. The device of claim 1 wherein:
said foot frame assembly is de-mountable coupled to said leg frame assembly, and said leg frame assembly is de-mountable coupled to said track pad assembly.

3. The device of claim 1 wherein:
said foot frame assembly is coupled to said leg frame assembly by telescoping tube members, and said leg frame assembly is coupled to said track pad assembly by telescoping tube members.

4. The device of claim 1 further including:
a support boot for said patient foot; and
one or more support straps to position said patient leg.
